(19) United States
(12) Patent Application Publication
(10) Pub. No.: US 2026/0113685 A1
(43) Pub. Date: Apr. 23, 2026

(54) COMMUNICATION SYSTEM AND IN-VEHICLE DEVICE

(71) Applicant: TOYOTA JIDOSHA KABUSHIKI KAISHA, Toyota-shi (JP)

(72) Inventors: Koji TAKEOKA, Chiyoda-ku (JP); Naoya KANEKO, Kita-ku (JP)

(73) Assignee: TOYOTA JIDOSHA KABUSHIKI KAISHA, Toyota-shi (JP)

(21) Appl. No.: 19/360,507

(22) Filed: Oct. 16, 2025

(30) Foreign Application Priority Data
Oct. 22, 2024 (JP) 2024-185710

(51) Int. Cl. H04W 40/02; H04W 4/40

(52) U.S. Cl. CPC H04W 40/02; H04W 4/40

(57) ABSTRACT

A communication system comprises one or more in-vehicle devices capable of using a plurality of communication lines, and a server apparatus, wherein the server apparatus transmits, to the in-vehicle device, reference data indicating criteria for selecting a communication line used by the in-vehicle device for communicating outside a vehicle among the plurality of communication lines, based on an origin of data to be communicated and amount of data communication; and the in-vehicle device selects a communication line used for communicating outside the vehicle based on the received reference data.

### CROSS REFERENCE TO THE RELATED APPLICATION

This application claims the benefit of Japanese Patent Application No. 2024-185710, filed on October 22, 2024, which is hereby incorporated by reference herein in its entirety.

### BACKGROUND

### Technical Field

The present disclosure relates to a communication system.

### [Description of the Related Art]

In communication devices, there is a technology that uses multiple communication profiles. In this regard, for example, Patent Document 1 discloses a communication device comprising a profile area for storing profiles used to utilize lines of a mobile network operator, and an application area for storing applications for tamper detection, where the profile area storing multiple profiles and the application area are separated.

### [Prior Art Documents]

### [Patent Document]

[Patent Document 1] Japanese Patent Laid-Open Application Publication No. 2022-180105

### SUMMARY

This disclosure aims to appropriately switch among a plurality of communication lines.

The present disclosure in its one aspect provides a communication system comprising one or more in-vehicle devices capable of using a plurality of communication lines, and a server apparatus, wherein the server apparatus transmits, to the in-vehicle device, reference data indicating criteria for selecting a communication line used by the in-vehicle device for communicating outside a vehicle among the plurality of communication lines, based on an origin of data to be communicated and amount of data communication; and the in-vehicle device selects a communication line used for communicating outside the vehicle based on the received reference data.

Furthermore, the present disclosure in its another aspect provides an in-vehicle device capable of using a plurality of communication lines comprising a controller comprising at least one processor configured to perform: receiving reference data, which indicates criteria for selecting a communication line used for communicating outside a vehicle based on an origin of data to be communicated and amount of data communication among the plurality of communication lines from a prescribed server apparatus,; and selecting a communication line used for communicating outside the vehicle based on the reference data.

As other aspects, there is also a program for executing the above information processing method performed by the communication system on a computer, or a computer-readable storage medium that non-temporarily stores the program.

According to the present disclosure, each of the plurality of communication lines can be appropriately switched.

### BRIEF DESCRIPTION OF THE DRAWINGS

FIG. 1 is a schematic diagram of a vehicle communication network according to a first embodiment.

FIG. 2 is a diagram illustrating the components included in the DCM according to the first embodiment.

FIG. 3 is a diagram illustrating the components included in the communication device according to the first embodiment.

FIG. 4 is a diagram illustrating the components included in the server device according to the first embodiment.

FIG. 5 is a sequence diagram of the processing executed by the communication system according to the first embodiment.

FIG. 6 is a flowchart of the processing executed by the DCM included in the communication system according to the second embodiment.

### DESCRIPTION OF THE EMBODIMENTS

### (Summary)

In recent years, the connectivity of automobiles has progressed, and the number of vehicles equipped with communication devices has increased. By having an in-vehicle communication device communicate with, for example, a server device (such as an application server) via a cellular communication network, various services can be provided to the occupants of the vehicle.

A typical in-vehicle communication device includes a communication module conforming to a specific standard and a SIM card for connection to a particular carrier network, allowing communication over the carrier network corresponding to the SIM card.

However, if there is only one carrier network available for the wireless communication device, communication will be interrupted when a communication failure occurs in that carrier network. Therefore, there is a technology that can authenticate another SIM card to connect to a carrier network independently contracted by the vehicle user and provide services to the connected car via communication through another carrier network by connecting to a server device (such as an application server).

When an in-vehicle communication device can communicate via multiple carrier networks corresponding to multiple SIM cards, it is desirable to appropriately switch between the multiple carrier networks according to predetermined conditions.

The communication system according to the present disclosure solves the aforementioned problem.

A communication system according to one embodiment of the present disclosure comprises one or more in-vehicle devices capable of using a plurality of communication lines, and a server apparatus, wherein the server apparatus transmits, to the in-vehicle device, reference data indicating criteria for selecting a communication line used by the in-vehicle device for communicating outside a vehicle among the plurality of communication lines, based on an origin of data to be communicated and amount of data communication; and the in-vehicle device selects a communication line used for communicating outside the vehicle based on the received reference data.

Reference data is information that indicates the criteria for selecting the communication line to be actually used for communication from among multiple communication lines available to the in-vehicle device.

The server apparatus transmits criterion data that indicates the standards for selecting the communication line used for communicating with external devices to the in-vehicle device, and the in-vehicle device selects the communication line used for communicating with external devices based on the criterion data received from the server apparatus. The reference data serves as the criteria to select the communication line to be used based on the source of the data being communicated and the amount of data communication. This allows for responses such as using different lines for important data and other data or switching lines depending on whether the amount of data communication exceeds a predetermined amount.

According to such a configuration, it is possible to appropriately switch among multiple communication lines based on factors like the source of the data and the amount of data communication.

Also, the plurality of communication lines at least includes first communication line contracted by a manufacturer of the vehicle equipped with the in-vehicle device, and second communication line contracted by a user of the vehicle.

Also, the server apparatus generates the reference data indicating that until the amount of data communication communicated through the second communication line reaches a predetermined amount, the second communication line should be preferentially selected.

As a result, the server apparatus according to the present disclosure can make full use of the surplus data communication amount in the contracted communication line of the vehicle user in the connected car.

Further, the server apparatus generates the reference data indicating that when the amount of data communication of data communicated via the second communication line reaches a predetermined amount, system data related to travel of the vehicle are communicated via the first communication line, and user data unrelated to the travel of the vehicle are communicated via the second communication line, among data to be communicated by the in-vehicle device.

As a result, for example, until a predetermined data communication amount (such as the amount of data communication that a user can use at a flat rate on the contracted line) is reached, communication is conducted on the line contracted by the user, and thereafter, communication is conducted on the line contracted by the service provider. According to this configuration, the server apparatus disclosed herein can efficiently switch between the communication line contracted by the vehicle manufacturer and the communication line contracted by the user of the vehicle in connected cars.

Further, an in-vehicle device capable of using a plurality of communication lines comprises a controller comprising at least one processor configured to perform: receiving reference data, which indicates criteria for selecting a communication line used for communicating outside a vehicle based on an origin of data to be communicated and amount of data communication among the plurality of communication lines from a prescribed server apparatus; and selecting a communication line used for communicating outside the vehicle based on the reference data.

As a result, the in-vehicle device related to the present disclosure can achieve the same effects as the above-mentioned communication system.

Hereinafter, specific embodiments of the present disclosure will be described with reference to the drawings. Unless otherwise noted, the hardware configuration, module configuration, functional configuration, etc., described in each embodiment do not intend to limit the technical scope of the disclosure to those alone.

### [First Embodiment]

### [Overview of the Communication System]

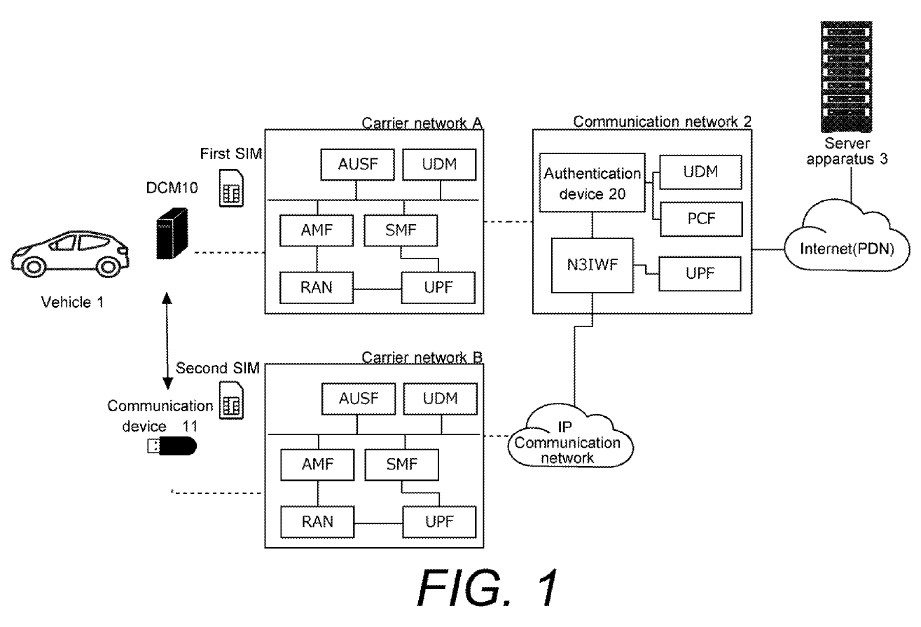

An overview of the communication system according to the first embodiment will be described with reference to FIG. 1. FIG. 1 is a schematic diagram of the vehicle communication network according to the first embodiment. The communication system according to this embodiment is comprised of DCM10 installed in Vehicle 1, Communication device 11 externally connected to DCM10, and Server device 3. Furthermore, DCM10 and Server device 3 are connected via Carrier network A and 2, or Carrier network B and Communication network 2. Communication network 2 is a network that includes multiple communication devices, including Authentication device 20. Note that the Vehicle 1 and Communication device 11 included in the system may be multiple.

Vehicle 1 is a connected car capable of with any server apparatus via wireless communication. Vehicle 1 can provide various services by communicating with an external server apparatus through DCM10, a wireless communication device. Examples of such services include navigation services, remote control services (e.g., remote air conditioning), in-vehicle Wi-Fi services, and emergency call services. In addition to the illustrated devices, Vehicle 1 may also be equipped with onboard terminals that provide these services.

DCM10 is a device that performs wireless communication with a predetermined network to connect a component possessed by Vehicle 1 (for example, an in-vehicle terminal) and an external device such as Server apparatus 3 or an application server that provides various services mentioned above. In this embodiment, DCM10 is configured to be able to connect to a predetermined cellular communication network. DCM10 is constructed with an eUICC (Embedded Universal Integrated Circuit Card) for identifying the user. The eUICC may be a physical SIM card or an eSIM, among others. Hereinafter, the eUICC possessed by the DCM10 is referred to as the first SIM.

In the illustrated example, DCM10 is configured to be able to communicate with Carrier network A, which constitutes the cellular communication network. Carrier network A includes base stations of the cellular communication network and control devices that manage mobile communication terminals, among other components.

In this embodiment, Carrier network A is connected to Communication network 2. Communication network 2 is a network that connects Carrier network A and a PDN (Packet Data Network) such as the Internet.

While Carrier network A is a network operated by a telecommunications operator, Communication network 2 can be a system operated by the manufacturer of Vehicle 1 or others. By interconnecting these networks, it becomes possible, for example, to provide unique services to Vehicle 1 through Communication network 2.

In this embodiment, Carrier network A provides only the communication line, while Communication network 2 handles the authentication of DCM 10 and the provision of services to DCM 10. DCM 10 includes a first SIM that stores profile information required for authentication by Communication network 2. The first SIM is issued by the operator managing Communication network 2 (for example, a vehicle manufacturer). Communication network 2 includes Authentication device 20 for authenticating DCM 10.

DCM10 connects to Communication network 2 via Carrier network A and receives authentication from Communication network 2 using the profile information stored in the first SIM. In this embodiment, Authentication device 20 included in Communication network 2 performs authentication of DCM10 based on the profile information included in the first SIM. Once authenticated, DCM10 can communicate with the PDN (for example, the Internet) and can start communication with Server device 3 or an external device.

Also, as shown in FIG. 1, DCM 10 is configured to include Communication device 11 in such a way that it can be connected externally. For example, DCM 10 can connect Communication device 11 via an interface such as USB and is configured to send and receive data through Communication device 11. In other words, DCM 10 is configured to enable USB tethering.

Communication device 11 is a device that can perform wireless communication according to any communication standard. For example, even if the cellular communication network (Carrier network A) used by DCM 10 goes down, DCM 10 can continue communication via Communication device 11.

Communication device 11 is a device that includes the same communication functions as DCM 10. Communication device 11 includes a second SIM and can connect to Carrier network B based on the profile information stored in the second SIM.

Carrier network B is a cellular communication network that is independent from Carrier network A and Communication network 2. For example, the user of Vehicle 1 selects Carrier network B to enter into a contract and prepares a communication device 11 corresponding to that contract.

Since Carrier network B is a network independent of Communication network 2, these two networks cannot be connected to each other as they are. Therefore, in this embodiment, the DCM10 connected to Carrier network B can establish an IPsec tunnel with the N3IWF of Communication network 2, enabling a connection between Carrier network B and Communication network 2 via the IP communication network beyond it.

Communication network 2 includes a gateway (N3IWF) for accommodating access from an IP communication network. The N3IWF is a gateway for accommodating untrusted non-3GPP (registered trademark) wireless access. As a result, Communication network 2 can accept access via the wireless access network (Carrier network A) as well as access via the IP communication network (via Carrier network B). Note that the IP communication network is typically the internet, but it may be other than that.

DCM 10 connected to Carrier network B can communicate with Communication network 2 via a route passing through the IP communication network (Internet).

In this way, DCM 10 can choose whether the device itself connects to Carrier network A or connects to Carrier network B using the communication device 11.

In this embodiment, when communication with an external device is required, DCM 10 determines which line to use based on data received in advance from Server apparatus 3.

Server apparatus 3 generates data indicating the criteria for selecting between two networks, Carrier network A and Carrier network B, which can connect to the Communication network 2 (hereinafter referred to as reference data), and provides it to DCM 10.

The reference data defines the circumstances under which communication is conducted using which communication line.

For example, if the contract for the communication line via Carrier network A is usage-based depending on the amount of data communication, and the contract for the communication line via Carrier network B is a fixed-rate system with a predetermined data communication amount limit, it may be preferable from a cost standpoint to communicate via Carrier network B until a certain data communication amount is reached.

In this case, when the amount of data communication over the communication line via Carrier network B reaches a predetermined amount, a method can be considered in which the communication line for communicating only the data necessary for vehicle operation (system data) is switched to the communication line via Carrier network A, while the data sent and received according to user requests (user data) remains on the communication line via Carrier network B.

Server apparatus 3 generates reference data that indicates the criteria for selecting such communication lines and provides it to DCM 10.

Then, DCM10 selects a communication line for transmitting or receiving data from the vehicle, based on the above reference data, choosing between a communication line via Carrier network A and a communication line via Carrier network B.

According to this configuration, the user of Vehicle 1 can appropriately switches among a plurality of communication lines according to the data source and data communication amount, among other factors.

### [Overview of authentication process]

When DCM10 is connected to Communication network 2 via Carrier network A, Communication network 2 can verify the legitimacy of DCM10 using the SIM (first SIM) it issued. On the other hand, when DCM10 is connected via Carrier network B, only authentication by Carrier network B (authentication using the second SIM) is performed, so Communication network 2 cannot trust DCM10 as it is.

Therefore, in this embodiment, Communication network 2 (authentication device 20) authenticates DCM 10 connected via N3IWF using the authentication information included by the first SIM, the same as when connected via Carrier network A.

As a result, even if the communication path between DCM10 and Communication network 2 changes, Communication network 2 can continue robust authentication equivalent to cellular communication without changing the device configuration.

Furthermore, in this embodiment, Authentication device 20 shares the results of authenticating DCM 10 in this manner with Server apparatus 3. Authentication device 20 also includes a function to authenticate Server apparatus 3 and shares the results of authenticating Server apparatus 3 with DCM 10. The authentication results may be transmitted or shared using a predetermined API (Application Programming Interface).

### [Overview of Processing on the Network]

Next, the flow of the aforementioned process will be explained in detail based on the components include by each network. In this embodiment, Carrier network A is a communication system conforming to the 5G standard. Carrier network A includes a Radio Access Network (hereinafter, RAN), a function for managing the sessions of communication terminals including In-vehicle device 10 (Session Management Function, hereinafter SMF), a function for managing the mobility of communication terminals (Access and Mobility Management Function, hereinafter AMF), a function for data relay in the user plane (User Plane Function, hereinafter UPF), and others. Furthermore, Carrier network A includes functions such as user authentication (Authentication Server Function, hereinafter AUSF) and acquiring subscriber information (Unified Data Management, hereinafter UDM). Note that each function can also be read as a "device."

Communication network 2 is also a communication system based on the 5G standard. Communication network 2 includes a gateway (N3IWF) that accommodates access from the IP communication network, Authentication device 20, a UPF which serves as a gateway for connection to external networks, and a PCF.

Authentication device 20 executes a process to authenticate user terminals including In-vehicle device 10. Authentication device 20 corresponds to the AMF and AUSF in the 5G system. Authentication device 20 is connected to the UDM and performs user device authentication based on information stored in the database (subscriber information corresponding to the first SIM).

PCF (Policy Control Function) is a function that performs QoS (Quality of Service) control, policy control, and charging management.

Carrier network A is configured to be able to communicate with Communication network 2. As a result, the user device (DCM10) connected to Carrier network A can communicate with Communication network 2.

Authentication device 20 performs the process of authenticating user terminals including DCM 10. Authentication device 20 corresponds to devices such as AMF and AUSF in the 5G system. Authentication device 20 is connected to the UDM and performs authentication of the user equipment based on information stored in the database (subscriber information corresponding to the first SIM).

Carrier network B includes the function to authenticate a mobile communication terminal (communication device 11) connected via a base station (gNB). Additionally, Carrier network B has an N3IWF connected to an IP communication network (for example, the Internet). This allows a mobile communication terminal (communication device 11) connected to Carrier network B to communicate with the IP communication network.

In cases where DCM10 establishes a connection using the wireless communication module it includes, it sends a connection request to Communication network 2 via the Carrier network A. At this time, DCM10 uses the authentication information contained in the profile information stored in the first SIM (hereinafter referred to as the first profile) to undergo authentication from the authentication device 20.

Furthermore, in cases where DCM10 establishes a connection via Communication device 11, it sends a connection request to Communication network 2 with the N3IWF, which Communication network 2 includes, as the destination. Since N3IWF is a gateway that accommodates access from the IP communication network, DCM10 can communicate with Communication network 2 through the N3IWF. At this time, DCM10 receives authentication from Authentication device 20 using the authentication information included in the profile information (first profile) stored in the first SIM.

The connection request is processed by Authentication device 20 included in Communication network 2, and authentication is performed between DCM 10 and Authentication device 20. Authentication device 20 authenticates DCM 10 based on authentication information included in the first profile. Once authentication is completed, a path from DCM 10 to PDN is established, enabling communication between DCM 10 and Server apparatus 3 (or an external application server providing the service).

Furthermore, Authentication device 20 shares the result of authenticating DCM 10 with Server apparatus 3. As a result, Server apparatus 3 can verify the legitimacy of DCM 10 without exchanging certificates or the like.

That is, DCM 10 is configured to be authenticated by Authentication device 20 using the same authentication information (included in the first profile) regardless of the route to Communication network 2.

DCM10 selectively uses two routes based on reference data received from Server device 3: a route that directly connects to Communication network 2 via a cellular communication network, and a route that connects to Communication network 2 via an IP communication network using tethering, where authentication is received from Authentication device 20 using the same authentication information (profile information).

For example, when DCM 10 receives reference data indicating that if the amount of data communication on the communication line via Carrier network B from Server apparatus 3 is below a predetermined communication amount, system data and user data should be sent via that communication line, and if not, system data should be sent via a communication line through Carrier network A and user data via a communication line through Carrier network B, DCM 10 follows the reference data and sends system data and user data via the communication line through Carrier network B when the amount of data communication is below the predetermined communication amount. Additionally, when the amount of data communication on the communication line through Carrier network B is at or above the predetermined amount, DCM 10 sends system data via the communication line through Carrier network A and user data via the communication line through Carrier network B.

According to this configuration, it is possible to appropriately switch between a plurality of communication lines according to the source of the data and the amount of data communication.

### [Configuration of the communication system]

Next, the hardware configuration and software configuration of the communication system of this embodiment will be described.

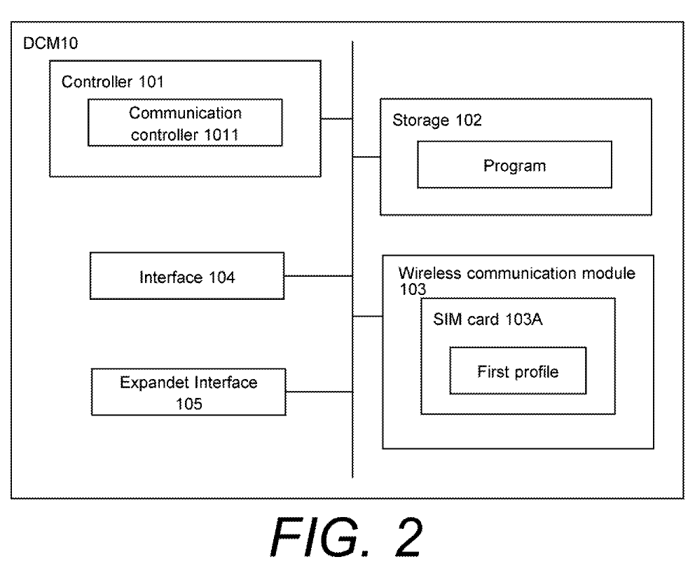

First, the configuration of DCM10 will be explained. FIG. 2 is a diagram illustrating the components included in DCM according to the first embodiment.

DCM10 can be configured as a computer that includes processors (CPU, GPU, etc.), main memory devices (RAM, ROM, etc.), and auxiliary storage devices (EPROM, hard disk drive, removable media, etc.). The auxiliary storage device stores the operating system (OS), various programs, various tables, etc., and by executing the programs stored there, it is possible to realize the respective functions (software modules) that meet predetermined objectives as described later. However, some or all of the functions may be realized as hardware modules by hardware circuits such as ASICs and FPGAs.

DCM10 is configured to include Control unit 101, Memory 102, Wireless communication module 103, Interface 104, and Expansion interface 105.

Controller 101 is a processing unit that realizes various functions of DCM10 by executing a predetermined program. Controller 101 can be realized by hardware processors such as a CPU. Controller 101 may also be configured to include RAM, ROM (Read Only Memory), cache memory, and the like.

In this embodiment, Controller 101 possessed by DCM10 is configured to have Communication controller 1011 as a software module. The software module may be realized by executing a program stored in Storage 102 by Controller 101 (CPU). Note that the information processing executed by the software module is equivalent to the information processing executed by Controller 101 (CPU).

Also, SIM card 103A (first SIM) built into Wireless communication module 103 is configured to store the first profile, which is SIM profile information. The first profile is a profile issued by the operator managing Communication network 2. The first profile is configured to include identification information such as IMSI (International Mobile Subscription Identity) and ICCID (Integrated Circuit Card ID), as well as authentication information (key information) for receiving SIM authentication, including AKA authentication.

Communication controller 1011 establishes a network connection in response to requests from vehicle components installed in Vehicle 1. Communication controller 1011 is configured to select the network to be used for the connection. For example, when the first SIM is inserted in DCM 10, DCM 10 can establish a network connection via Carrier network A. Also, if Communication device 11 with a second SIM is connected to DCM 10, DCM 10 can establish a network connection via Carrier network B. When a plurality of networks is available, Communication controller 1011 may determine the network to be used for the connection based on the user's selection.

Communication controller 1011, when performing network connection via Carrier network A, uses the profile information stored in the first SIM (first profile) to receive authentication from the authentication device 20. When establishing a network connection via Carrier network B, Communication controller 1011 first performs a process of requesting connection to Carrier network B from Communication device 11. Then, second, after Communication device 11 has connected to Carrier network B, it interacts with Communication network 2 (Authentication device 20) through Carrier network B and performs the process of receiving authentication from Authentication device 20.

Furthermore, Communication controller 1011 selects the communication line for communicating data with the outside according to reference data received from Server apparatus 3. For example, Communication controller 1011 selects an appropriate communication line from Carrier network A and Carrier network B as the communication line for communicating the data to the outside, depending on the origin of the data to be communicated. Also, Communication controller 1011 selects, for each data source, the communication line for communicating the data to the outside, either from Carrier network A or Carrier network B based on the amount of data communication already used on Carrier network B.

Communication controller 1011 receives reference data from Server apparatus 3 at a predetermined timing before starting communication. When the reference data is updated on Server apparatus 3, Server apparatus 3 may periodically communicate with Server apparatus 3 to obtain the latest reference data.

Storage 102 is a means for storing information and is composed of storage media such as RAM, magnetic disks, and flash memory. Storage 102 stores programs executed by Controller 101, as well as data used by these programs.

Wireless communication module 103 is a communication device that performs wireless communication with a predetermined network. In this embodiment, Wireless communication module 103 is configured to be capable of communicating with a predetermined cellular communication network (Carrier network A).

Wireless communication module 103 is configured to include a SIM card 103A. SIM card 103A is the first SIM in FIG. 1. SIM card 103A is configured as a microcomputer equipped with a CPU and storage device. SIM card 103A includes information (PLMN information) for connecting to Carrier network A, as well as authentication information for receiving authentication from Communication network 2.

Interface 104 is a communication interface for connecting DCM 10 to the in-vehicle network that Vehicle 1 includes. Interface 104 may be configured to include, for example, a network interface board that communicates using the CAN (Controller Area Network) protocol. DCM 10 can perform data communication with other components that Vehicle 1 includes (such as an in-vehicle terminal) through Interface 104.

Expansion interface 105 is an interface for mutually connecting DCM 10 and Communication device 11. Expansion interface 105 is, for example, a USB interface. DCM 10 is configured to be connectable to Communication device 11 via, for example, the USB interface.

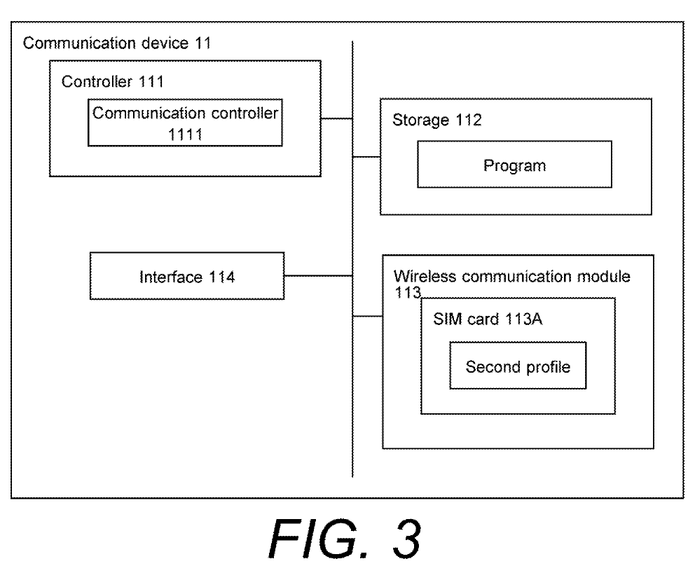

Next, the configuration of Communication device 11 will be explained. FIG. 3 is a diagram explaining the components included by Communication device 11 according to the first embodiment.

Communication device 11 is configured with a controller 111, storage 112, a wireless communication module 113, and an interface 114.

Controller 111 is a processing unit that implements various functions of Communication device 11 by executing a predetermined program, similar to controller 101. Controller 111 can be realized by hardware processors such as a CPU, for example.

In this embodiment, Controller 111 of Communication device 11 is configured to include Communication controller 1111 as a software module. The software module may be realized by executing a program stored in Storage 112 by Controller 111 (CPU). Note that the information processing executed by the software module is equivalent to the information processing executed by Controller 111 (CPU).

Communication controller 1111 establishes a network connection in response to a request from DCM 10. When there is a connection request from DCM 10, Communication controller 1111 makes the network connection via Carrier network B. At this time, Communication controller 1111 authenticates with the control device possessed by Carrier network B using the profile information (second profile) stored in the second SIM.

Storage 112 is a means for storing information and is composed of storage media such as RAM, magnetic disks, or flash memory. Storage 112 stores programs executed by controller 111 as well as data used by those programs.

Wireless communication module 113 is a communication device that performs wireless communication with a predetermined network. In this embodiment, Wireless communication module 113 is configured to be capable of communication with a predetermined cellular communication network (Carrier network B).

Wireless communication module 113 is configured to include a SIM card 113A. SIM card 113A is the second SIM in FIG. 1. SIM card 113A is configured as a microcomputer equipped with a CPU and a storage device. SIM card 113A includes information for connecting to the Carrier network B (PLMN information) and authentication information for receiving authentication from the network. The second SIM may be a physical SIM card or it may be an eSIM or the like.

In addition, SIM card 113A (second SIM) built into Wireless communication module 113 is configured to store a second profile, which is SIM profile information. The second profile is a profile issued by the communication carrier managing Carrier network B. Like the first profile, the second profile is configured to include identification information such as IMSI and ICCID, as well as authentication information (key information) for SIM authentication.

Interface 114 is an interface for mutually connecting DCM 10 and Communication device 11. Communication device 11 is configured to be connectable to DCM 10 via an interface such as USB, for example.

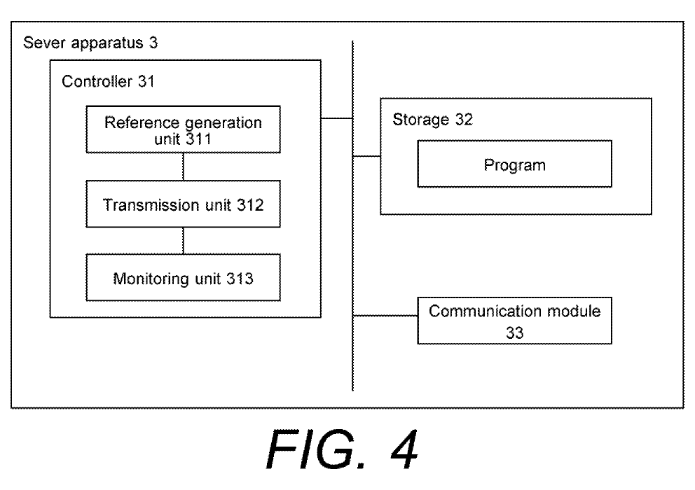

Next, the configuration of Server apparatus 3 will be explained. FIG. 4 is a diagram illustrating the components included in Server apparatus 3 according to the first embodiment.

Controller 31, like Controller 101, is a processing unit that realizes various functions of Server apparatus 3 by executing a predetermined program. Controller 31 can be implemented, for example, by a hardware processor such as a CPU.

In this embodiment, Controller 31 of Server apparatus 3 is configured to have two software modules, Reference generation unit 311 and Transmission unit 312. These software modules may be realized by executing programs stored in Storage 32 by Controller 31 (CPU). The information processing executed by the software modules is synonymous with the information processing executed by Controller 31 (CPU).

Reference generation unit 311 generates reference data, which serves as criteria for DCM10 to select the communication line used for data transmission and reception. For example, Reference generation unit 311 generates reference data such as "If the amount of data communication on the second communication line is below a predetermined amount, both system data and user data are communicated over the second communication line; otherwise, system data is communicated over the first communication line contracted by the vehicle manufacturer, and user data is communicated over the second communication line."

Reference generation unit 311 may generate reference data based on information obtained from the user. For example, if information is obtained from the user terminal used by the user indicating that data communication of up to 2 GB per month can be provided, Reference generation unit 311 can generate reference data that sets the upper limit of data communication per month to 2 GB. Therefore, Server apparatus 3 may be configured to interact with a predetermined user terminal.

Transmission unit 312 sends the reference data generated by Reference generation unit 311 to DCM 10. Transmission unit 312 sends the reference data to DCM 10 via Communication module 33.

Monitoring unit 313 measures the amount of data communication of the second communication line used by DCM 10. Monitoring unit 313 stores the amount of data communication and may notify it upon request from the user. In addition, Monitoring unit 313 may determine the contents of incentives granted to the user based on the amount of data communication.

Monitoring unit 313 may notify the user terminal of the amount of data communication during a predetermined period. This allows the user to recognize the surplus amount of data communication during the predetermined period.

Storage 32 is a means for storing information and consists of storage media such as RAM, magnetic disks, and flash memory. Storage 32 stores programs executed by controller 111, data used by these programs, and so forth.

Communication module 33 is a communication device that communicates with a specified network. In this embodiment, Communication module 33 is configured to communicate with DCM 10 via Communication network 2.

### [Processing of the Communication System]

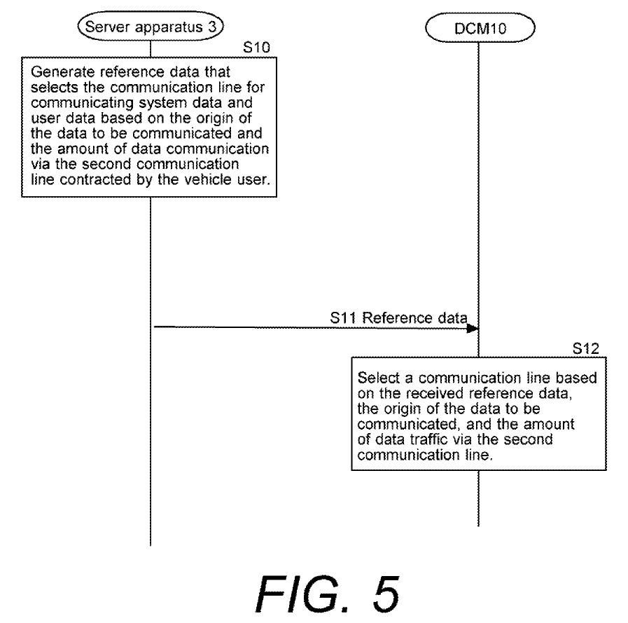

Next, the specific content of the processing performed by the communication system according to an embodiment of the present disclosure will be described. FIG. 5 is a sequence diagram of processing executed by the communication system according to the first embodiment. In FIG. 5, the processing by which Server apparatus 3 transmits generated reference data to DCM 10, and DCM 10 selects a communication line to use based on the reference data, is described.

When a trigger for generating reference data is input to Server apparatus 3, Server apparatus 3 begins the processing of step S10. Alternatively, Server apparatus 3 may start the processing of step S10 at predetermined intervals.

First, in step S10, Reference generation unit 1311 of Server apparatus 3 generates reference data that selects the communication line for communicating system data and user data based on the source of the data to be sent and received and the amount of data communication used on the second communication line contracted by the vehicle user. For example, Reference generation unit 311 of Server apparatus 3 generates reference data so that when the amount of data communication of the second communication line is below a predetermined amount, both the user data and system data are communicated through the second communication line; and when the amount of data communication of the second communication line is equal to or exceeds the predetermined amount, system data is communicated via the first communication line while user data is communicated via the second communication line. The reference data represents criteria for instructing DCM10 to select a communication line for communication the outside the vehicle. Here, as mentioned above, the first communication line is a communication line contracted by the vehicle manufacturer, while the second communication line is contracted by the vehicle user. System data includes information related to the vehicle's speed, direction of travel, and location information, as well as various information necessary for vehicle driving control. User data is information communicated based on the vehicle user's requests and includes data necessary for user services provided by the onboard device, for example. System data and user data originate from different sources.

Further, for example, Reference generation unit 1311 may generate reference data that allows sending both system data and user data via the second communication line when the data amount on the second communication line is below a predetermined amount, and, when the data amount on the second communication line reaches or exceeds the predetermined amount, sends only those system data whose importance is above a predetermined threshold via the first communication line.

Also, for example, Reference generation unit 311 may generate reference data indicating that the second communication line is preferentially selected until the amount of data communication of the data communicated via the second communication line reaches a predetermined data communication amount.

Additionally, Reference generation unit 311 may determine the amount of data communication available for use in data communications sent and received by DCM 10 based on the user's declaration and generate reference data. For example, a user may declare that up to 2 GB of the second communication line will be provided for DCM 10's communication in October 2024, and Reference generation unit 311 may specifically determine the said predetermined surplus amount based on this declaration.

Next, in step S11, Transmission unit 312 of Server device 3 transmits the reference data generated in step S10 to DCM 10. Server device 3 transmits the reference data to DCM 10 via Communication network 2.

Next, in step S12, Communication controller 1011 selects a communication line based on the reference data received, the origin of the data to be communicated, and the amount of data traffic used on the second communication line. For example, if Communication controller 1011 of DCM 10 determines that the amount of data traffic used on the second communication line is equal to or exceeds a predetermined value, Communication controller 1011 of DCM 10 may communicate system data via the first communication line and communicate user data via the second communication line. Alternatively, if Communication controller 1011 of DCM 10 determines that the amount of data traffic used on the second communication line has reached or exceeded a predetermined value, it may communicate only those system data with an importance level equal to or greater than a certain threshold via the first communication line. The importance level of each piece of system data may be predetermined or may be variably defined based on driving conditions. DCM 10 uses the first communication line for external communication. At this time, the transmission and reception of user data that is not essential for driving is restricted to below a predetermined level. As a result, when the data traffic on the second communication line is equal to or greater than the predetermined amount, part of the services provided to the user will be restricted.

Also, if it is determined that the data usage on the second communication line is below a specified amount, both system data and user data may be communicated over the second communication line.

Monitoring unit 313 of Server device 3 may measure the amount of data communication by DCM 10 using the second communication line. Monitoring unit 313 may notify the user of the measurement results of the amount of data communication using the second communication line by DCM 10. Furthermore, Monitoring unit 313 may notify DCM 10 of the measurement results regarding the amount of data communication using the second communication line, and DCM 10 may notify the user of the measurement results. Monitoring unit 313 may also determine an incentive to be granted to the user based on the measurement results. Here, the incentives may be granted in the form of coupons for services used by the user or discounts on usage fees for the first communication line, etc.

As described above, in this embodiment, when the amount of data communication on the second communication line reaches a predetermined amount or more, system data is communicated through the first communication line, and user data is communicated through the second communication line. Alternatively, when the amount of data communication on the second communication line reaches a predetermined amount or more, system data only is communicated through the first communication line, and the transmission and reception of user data are stopped. Then, when the amount of data communication on a second communication line, which is the communication line contracted by the user, is below a predetermined amount, both system data and user data are sent and received via the second communication line. However, the reference data is not limited to the examples given, as long as it shows the criteria for selecting a communication line according to the data source and the communication data amount of the second communication line. As a result, the communication system in this embodiment can appropriately switch between a plurality of communication lines according to the source of the data and the amount of data communication, among other factors.

### [Second embodiment]

In the first embodiment, DCM10 selects either the communication line contracted by the vehicle manufacturer or the second communication line contracted by the vehicle user, based on the data source and the amount of data communication of the second communication line. However, when a vehicle ridden by a user travels across national borders, the need for international roaming in communication is anticipated. In cases where international roaming occurs, the cost of using the communication line changes, making it potentially undesirable to select the communication line based solely on the reference data.

Also, if a communication line selected based on reference data is found to be faulty, DCM10 may be forced to select a communication line that is usable and not faulty instead of the one based on the reference data.

In addition, if a vehicle theft occurs, in order to prioritize the establishment of communication, DCM10 may have to select a communication line that remains available even after the theft, rather than a communication line according to the reference data.

Therefore, in the second embodiment, when such a predetermined event occurs, data transmission and reception is performed using a predetermined communication line without selecting a communication line according to the reference data. The predetermined communication line may be any communication line available at that location, or any communication line decided in advance.

Note that, as predetermined events, this embodiment exemplifies the occurrence of international roaming, theft, or communication failure, but others may also apply.

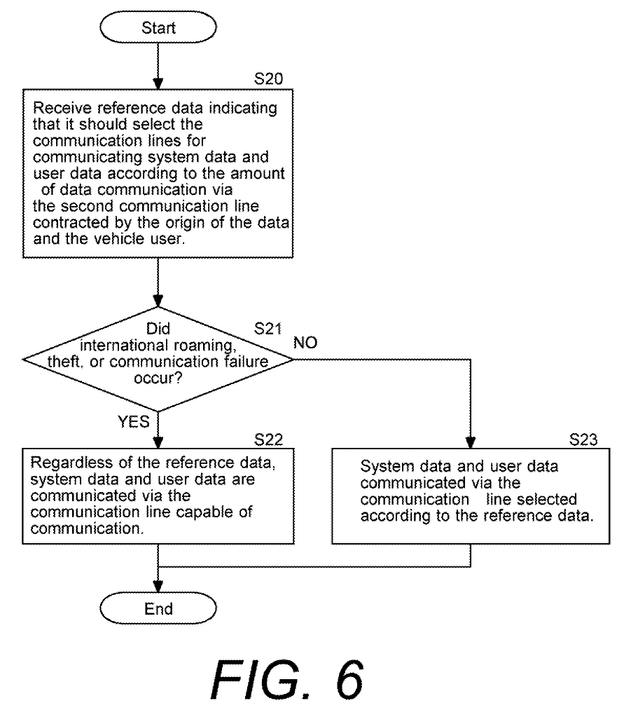

FIG. 6 is a flowchart of the processing executed by DCM10 included in the communication system according to the second embodiment. Matters that are the same as those described in FIG. 5 are omitted in the explanation of FIG. 6.

First, in step S20, Communication controller 1011 of the DCM10 receives reference data indicating that it should select the communication lines for communicating system data and user data according to the amount of data communication used on the second communication line contracted by the data origin and the vehicle user.

Next, in step S21, Communication controller 1011 of DCM10 determines whether international roaming has occurred, whether the vehicle has been stolen, or whether a communication failure has occurred in communication from the vehicle. This step results in a positive determination if Communication controller 1011 judges that international roaming has occurred in communication from the vehicle, that the vehicle has been stolen, or that a communication failure has occurred in communication from the vehicle.

If a positive determination is made in this step, the process transitions to step S22.

If a negative determination is made in this step, the process transitions to step S23.

When the process transitions to step S22, Communication controller 1011 of DCM10 transmits and receives both system data and user data over the communication line capable of communication, regardless of the reference data. For example, if the second communication line is unable to communicate due to a communication failure, it is permissible to communicate both system data and user data over the first communication line. Communication controller 1011 may send and receive only important data among the system data over a communicable communication line. In this way, Communication controller 1011 can continue communication by appropriately selecting an available communication line even when an abnormal communication situation occurs due to international roaming, theft, or communication failure.

In addition, if there are a plurality of communication lines capable of communication, any of the lines may be selected, or one of the predetermined communication lines may be selected. For example, if communication lines contracted by the user and those contracted by the vehicle manufacturer are both available, the latter may be given priority.

When the process transitions to step S23, Communication controller 1011 of DCM10 sends and receives system data and user data over the communication line selected according to the reference data. For example, Communication controller 1011 of DCM10 may send and receive system data using the first communication line and send and receive user data using the second communication line when the amount of data communication used on the second communication line reaches or exceeds a predetermined amount according to reference data. Also, for example, Communication controller 1011 may communicate both system data and user data on the second communication line when the amount of data communication used on the second communication line is below a predetermined amount according to the reference data.

As described above, the communication system according to this embodiment communicates system data and user data over communication lines selected according to reference data when no predetermined event has occurred. If a predetermined event such as international roaming, theft, or communication failure occurs, communication lines capable of communication are selected to communicate both system data and user data. As a result, the communication system in this embodiment can appropriately switch between a plurality of communication lines so that communication can continue uninterrupted even when abnormalities occur in the communication conditions.

### [Other modification]

The above embodiment is merely an example, and the present disclosure can be appropriately modified and implemented without departing from the gist thereof. For example, the processes and means described in the present disclosure can be freely combined and implemented as long as no technical contradictions occur.

For example, Monitoring unit 313 of Server apparatus 3 measures the amount of data communication sent and received by DCM 10 using the second communication line and notifies the user of the amount of data communication used. Based on this, the user can declare the amount of data communication for a second communication line available for communication with DCM10 from the following month onwards, and Reference generation unit 311 can generate reference data based on this.

This disclosure can also be realized by supplying a computer program that implements the functions described in the above embodiments to a computer, and by one or more processors included in the computer reading and executing the program. Such a computer program may be provided to the computer by a non-transitory computer-readable storage medium connectable to the computer's system bus, or it may be provided to the computer via a network. A non-temporary computer-readable storage medium includes any type of disk, such as magnetic disks (floppy disks (registered trademark), hard disk drives (HDD), etc.), optical disks (CD-ROMs, DVD disks, Blu-ray disks, etc.), read-only memory (ROM), random-access memory (RAM), EPROM, EEPROM, magnetic cards, flash memory, optical cards, or any suitable type of medium for storing electronic instructions.

What is claimed is:

1. A communication system comprising one or more in-vehicle devices capable of using a plurality of communication lines, and a server apparatus,
wherein the server apparatus transmits, to the in-vehicle device, reference data indicating criteria for selecting a communication line used by the in-vehicle device for communicating outside a vehicle among the plurality of communication lines, based on an origin of data to be communicated and amount of data communication; and
the in-vehicle device selects a communication line used for communicating outside the vehicle based on the received reference data.

2. The communication system according to claim 1, wherein the plurality of communication lines at least includes a first communication line contracted by a manufacturer of the vehicle equipped with the in-vehicle device, and a second communication line contracted by a user of the vehicle.

3. The communication system according to claim 2, wherein the server apparatus generates the reference data indicating that until the amount of data communication communicated through the second communication line reaches a predetermined amount, the second communication line should be preferentially selected.

4. The communication system according to claim 2, wherein the server apparatus generates the reference data indicating that when the amount of data communication of data communicated via the second communication line reaches a predetermined amount, system data related to travel of the vehicle are communicated via the first communication line, and user data unrelated to the travel of the vehicle are communicated via the second communication line, among data to be communicated by the in-vehicle device.

5. An in-vehicle device capable of using a plurality of communication lines comprising a controller comprising at least one processor configured to perform:
receiving reference data, which indicates criteria for selecting a communication line used for communicating outside a vehicle based on an origin of data to be communicated and amount of data communication among the plurality of communication lines from a prescribed server apparatus; and
selecting a communication line used for communicating outside the vehicle based on the reference data.
